(19) United States
(12) Patent Application Publication
(10) Pub. No.: US 2005/0007949 A1
(43) Pub. Date: Jan. 13, 2005

(54) Traffic distribution control apparatus and method

(75) Inventor: Akihito Okura, Yokosuka-shi (JP)

Correspondence Address: CROWELL & MORING LLP;INTELLECTUAL PROPERTY GROUP, P.O. BOX 14300, WASHINGTON, DC, 20044-4300, US

(73) Assignee: NTT DoCoMo, INC., TOKYO (JP)

(21) Appl. No.: 10/832,235

(22) Filed: Apr. 27, 2004

(30) Foreign Application Priority Data
May 1, 2003 (JP) 2003-126602

(51) Int. Cl. H04J 3/14; H04L 12/26; H04J 1/16

(52) U.S. Cl. 370/217; 370/237

(57) ABSTRACT

When it is determined in a simplex method whether or not the existing path realized by routers R1 to R7 configuring a network can support the requested traffic, the optimal traffic distribution can be obtained although a prepared path group has a bottleneck link and has no sufficient band in a prepared path, etc. When there is no optimal solution in the simplex method, a bottleneck link is found, a bypass is added, and the simplex method is further applied. Thus, it can be determined whether or not the requested traffic can be accommodated by the current path. When it cannot be accommodated, only a necessary path can be added, and the optimal traffic distribution can be performed by setting the objective function based on the network cost such as the consumption of network resources, a delay, the number of hops, etc.

### BACKGROUND OF THE INVENTION

1. Field of the Invention

The present invention relates to a traffic distribution control apparatus and a traffic distribution control method, and more specifically to a traffic distribution control apparatus and a traffic distribution control method for determining whether or not an existing path realized by a router configuring the network can support requested traffic, and controlling the traffic to be distributed in the network by adding only a necessary path and assigning the optimal traffic to each path if it is determined that the existing path cannot support the requested traffic.

2. Description of the Related Art

A network such as the Internet, etc. constantly has the possibility of a flow of traffic exceeding the band of the current path. In such a network, it is a very important problem to determine whether or not the current path is sufficient for the traffic, and how the necessary path is to be increased if the current path is not sufficient.

The problem of determining whether or not the current path is sufficient for the traffic is standardized as a problem of linear programming. This problem is described below by referring to FIGS. 14A to 14D. FIGS. 14A to 14D show a network (hereinafter referred to as an IP network) configured by a plurality of routers. In the IP network shown in FIGS. 14A to 14D, routers R1, R2, R3, R4, R5, R6, and R7 are sequentially connected. The router R7 is connected to the router R1, thereby forming a circular structure. The router R3 is directly connected to the router R6.

The numbers “10” and “20” shown in FIG. 14A indicate the bands (Mbps) of links. That is, in this example, the band of the link between the routers R2 and R3 is 10 Mbps, and the band of the link between other routers is 20 Mbps. The resource consumption in all links is assumed to be “1”.

The traffic is 10 Mbps in each of the path from the router R1 to the router R4, the path from the router R2 to the router R4, and the path from the router R7 to the router R4.

As shown in FIG. 14B, there are two paths a₁ and a₂ between the routers R1 and R4. As shown in FIG. 14C, there are two paths b₁ and b₂ between the routers R2 and R4. As shown in FIG. 14D, there are the path c₁ between the routers R7 and R4. It is assumed that the flow rate in each path is variable, and is collectively referred to as a path group variable.

The conditional expression of the linear programming method is represented as follows. That is, the objective function is represented by
f=3a₁+4a₂+2b₁+5b₂+3c₁ (1)

In the linear programming method, the objective function is minimized. The restrictive expression of a traffic amount is represented by:
a₁+a₂=10 (2)
b₁+b₂=10 (3)
c₁=10 (4)

The restrictive expression of a link band is represented by:
a₁+b₁<10 (5)
a₂+b₂+c₁<20 (6)

Under the above-mentioned conditions, the following expression can be obtained.
(a₁, a₂, b₁, b₂, c₁)=(0, 10, 10, 0, 10) (7)

As described above, an appropriate objective function is set with a path set as a variable, and the restrictive condition (not exceeding a link band, etc.) for a path and the restrictive condition ( . . . Mbps for a path, etc.) for a traffic amount are set. With the restrictions, an inequality is converted into an equation (standard system) using a non-negative slack variable. A slack variable refers to a variable indicating the room for the condition for an equation.

The method for solving a problem of the linear programming using the standard system can be a well-known simplex method. In the simplex method, the geometric convex polyhedron enclosed by planes (hyperplanes) under restrictive conditions or a simplex is set as a feasible region, and a point to obtain the maximum (or minimum) objective function in the feasible region is detected.

Since an objective function is linear, it has a tilt. If the objective function is increased (or decreased) in the direction of the tilt, the vertex of a feasible region can be reached. The vertex indicates a vector to obtain the maximum (or minimum) objective function in a feasible region. The vector is referred to as the optimal feasible vector.

The determination of a solution of a simplex can be made using the feasible region. When no feasible region exists, there is no optimal feasible vector, or no solution. That is, since the current path has no variable satisfying the specified condition, the current path is not sufficient. On the other hand, the optimal feasible vector obtained when there is a feasible region indicates the most preferable traffic distribution in accordance with the objective function.

The simplex method is described in, for example,

Non-patent Document 1.

(Non-patent Document 1)

Masao Iri and Takashi Furubayashi “Network Theory” in OR Library 12, published by Japanese Scientific Technology Association, 1884

As described above, in the method of using the simplex method as a problem of linear programming, the presence/absence of a solution is determined, and the optimal solution is returned depending on the objective function when there is a solution. Thus, the method can be recognized as a very effective method.

However, in the above-mentioned conventional technology, the simplex method is used for an advancely prepared path group. For example, the simplex method is applied to the paths a₁, a₂, b₁, b₂, and c₁ shown in FIGS. 14A to 14D.

Therefore, although less paths can sufficiently work, calculations are performed on all paths, and the amount of calculations can be redundant. Furthermore, the advancely prepared paths in a prepared path group share a bottleneck link, and there can be the case in which the band is not sufficient. In this case, there is the demerit that the above-mentioned conventional method cannot sufficiently work.

### DISCLOSURE OF THE INVENTION

The present invention has been developed to solve the above-mentioned problems with the conventional technology, and aims at providing a traffic distribution control apparatus and a traffic distribution control method capable of obtaining the most preferable traffic distribution even when the amount of calculations is redundant and when there is no sufficient band prepared for the path group sharing a bottleneck link.

The traffic distribution control apparatus of the present invention controls traffic in a network to be distributed by determining whether or not an existing path realized by a router configuring the network can support requested traffic, and includes:

determination means for determining whether or not the existing path can support the traffic by applying a simplex method to a problem of a linear programming formed by an objective function and a restrictive condition including traffic among routers configuring a network and information about a path in the network; and

bypass search means for searching for a bypass other than the existing path when the determination means determines that the existing path cannot support the traffic, wherein

the determination means further makes a determination by adding a bypass searched for by the bypass search means. With the above-mentioned configuration, it can be determined whether or not the traffic can be accommodated by the current path, and only a necessary path can be added so that the traffic can be optimally distributed when the traffic cannot be accommodated.

In the traffic distribution control apparatus of the present invention, the determination means finds a bottleneck link causing a factor disabling the support of the requested traffic by applying the simplex method to an auxiliary objective function determined by the restrictive condition; and

the bypass search means searches for the bypass for bypassing the bottleneck link. With the above-mentioned configuration, the bottleneck link can be found unlike the conventional technology, and a bypass is added and the traffic can be optimally distributed.

In the traffic distribution control apparatus of the present invention, the bypass search means searches for the bypass using an algorithm of searching for the shortest path based on the link cost among the routers. By applying the algorithm described later, the shortest path can be easily searched for.

In the traffic distribution control apparatus of the present invention, the determination means can perform the determination at predetermined intervals. Thus, a path can be periodically set.

In the traffic distribution control apparatus of the present invention, the determination means performs the determination based on the monitor result of each traffic state of the router configuring the network. Thus, when traffic exceeding a predetermined amount enters at a burst, the setting of the path can be updated.

The traffic distribution control apparatus of the present invention further includes traffic determination means for determining traffic for minimizing the cost of the network based on a determination result of the determination means. The traffic can be optimally distributed with only a necessary path added by determining the traffic for minimizing the consumption of the resources of the network, minimizing the delay, and setting the smallest number of hops.

In the traffic distribution control apparatus of the present invention, when the traffic determination means makes a determination, and when the traffic includes a plurality of classes indicating priorities, the traffic depends on the classes. With the configuration, although there are a plurality of classes in requested traffic, the optimal path can be set depending on the priority, thereby optimally distributing the traffic.

The traffic distribution control method of the present invention controls traffic in a network to be distributed by determining whether or not an existing path realized by a router configuring the network can support requested traffic, and includes:

a determining step of determining whether or not the existing path can support the traffic by applying a simplex method to a problem of a linear programming formed by an objective function and a restrictive condition including traffic among routers configuring a network and information about a path in the network; and

a bypass searching step of searching for a bypass other than the existing path when the determining step determines that the existing path cannot support the traffic, wherein

a further determination is made in the determining step by adding a bypass searched for in the bypass searching step. In this method, it can be determined whether or not the traffic can be accommodated in the current path, and only a necessary path can be added when it cannot be accommodated, thereby optically distributing the traffic.

The traffic distribution control method of the present invention further includes a traffic determining step of determining traffic for minimizing consumption of resources of the network based on the determination result of the determining step. With the configuration, the traffic can be optimally distributed after adding an only necessary path.

As described above, according to the present invention, it is determined in the simplex method whether or not the current path is sufficient for the traffic, and when it is not sufficient, a bottleneck link is found using the characteristics of the simplex method and a path for bypassing the bottleneck link can be newly added to a path group so that only a path for a necessary point can be dynamically added. Furthermore, an objective function can be set such that the network cost can be minimized, thereby optimally distributing the traffic for the path obtained in the determination.

The present invention is different from the conventional technology in that when there is no optimal solution, a bottleneck link causing requested traffic not to be supported can be detected and a bypass can be added. In the conventional technology, when there is no optimal solution, the process immediately terminates without finding a bottleneck or adding a bypass.

A bottleneck can be found as follows. That is, a provisional feasible vector is used when the auxiliary objective function (described later) obtained based on the restrictive condition is not set to 0, but stops. The provisional vector indicates the state in which the maximum traffic flows through the current path. Therefore, a bottleneck link can be detected by comparing the value with the value of the link band.

A path which bypasses the bottleneck link can be obtained by various algorithms described below.

### BRIEF DESCRIPTION OF THE DRAWINGS

FIG. 1 shows an example of the configuration of the entire network including a traffic distribution control apparatus according to the present invention;

FIG. 2 is a block diagram showing the configuration of the traffic distribution control apparatus shown in FIG. 1;

FIG. 3 is a flowchart showing the operation of the traffic distribution control apparatus shown in FIG. 1;

FIG. 4 is a flowchart showing the operation of the traffic distribution control apparatus shown in FIG. 1;

FIGS. 5A and 5B show the outline of an example of applying a simplex method;

FIGS. 6A and 6B show the outline of another example of applying a simplex method;

FIGS. 7A to 7F show examples of the procedure of obtaining a bypass by applying Dijkstra;

FIGS. 8A to 8C are explanatory views showing the case in which an objective function is set such that the consumption of network resources can be minimized;

FIGS. 9A to 9G show the first embodiment of the present invention;

FIGS. 10A to 10G show the second embodiment of the present invention;

FIGS. 11A to 11G show the third embodiment of the present invention;

FIGS. 12A to 12C show the third embodiment of the present invention;

FIGS. 13A to 13D are explanatory views showing the case in which an objective function is set such that a delay can be minimized or based on the number of hops; and

FIGS. 14A and 14D are explanatory views showing the conventional method of determining whether or not the current path is sufficient for the traffic.

### BEST MODE FOR CARRYING OUT THE INVENTION

The embodiments of the present invention are described below by referring to the attached drawings. In each of the drawings, the components commonly shown in a plurality of the drawings are assigned the same reference numerals.

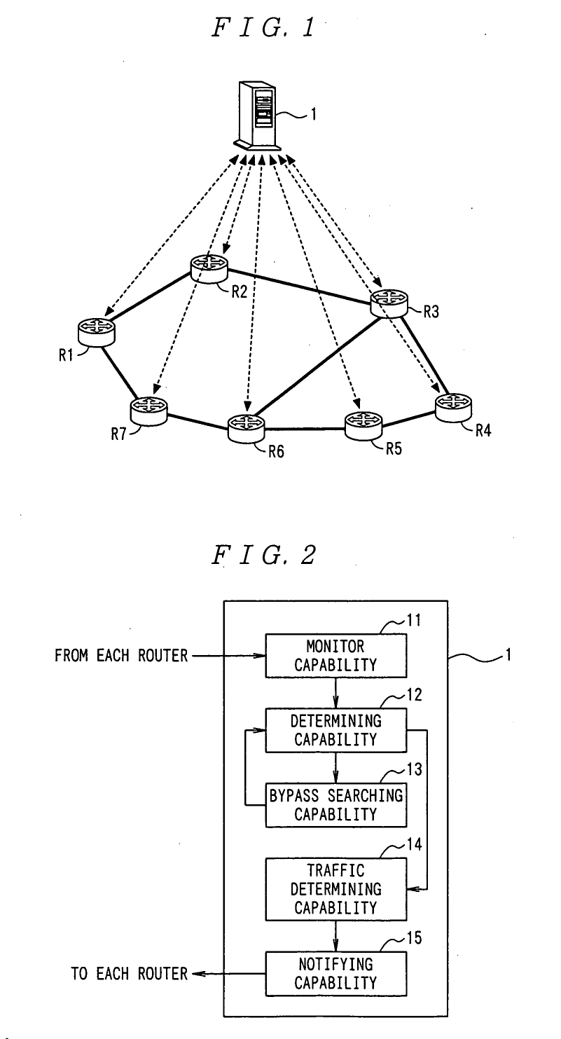

FIG. 1 shows the entire configuration of the network including the traffic distribution control apparatus according to the present invention. As shown in FIG. 1, in the present embodiment, an IP network forms a circular structure with the routers R1 to R7 sequentially connected. The router R3 is directly connected to the router R6.

The state of the traffic with the routers R1 to R7 is monitored by a traffic distribution control apparatus 1. The configuration of the traffic distribution control apparatus 1 is explained below by referring to FIG. 2.

The traffic distribution control apparatus 1 shown in FIG. 2 includes: a monitor capability 11 of receiving and monitoring the state of traffic of the routers R1 to R7 forming an IP network; a determining capability 12 of determining whether or not the existing path can support requested traffic by applying the simplex method; a bypass searching capability 13 of searching and obtaining a bypass other than an existing path when it is determined that the existing path cannot support the traffic; a traffic determining capability 14 of determining the traffic such that the network cost including the network resource consumption, delay, the number of hops, etc. can be minimized based on the determination result by the determining capability 12; and a notifying capability 15 of issuing a notification of the information about setting the traffic determined by the traffic determining capability 14 in each of the routers R1 to R7.

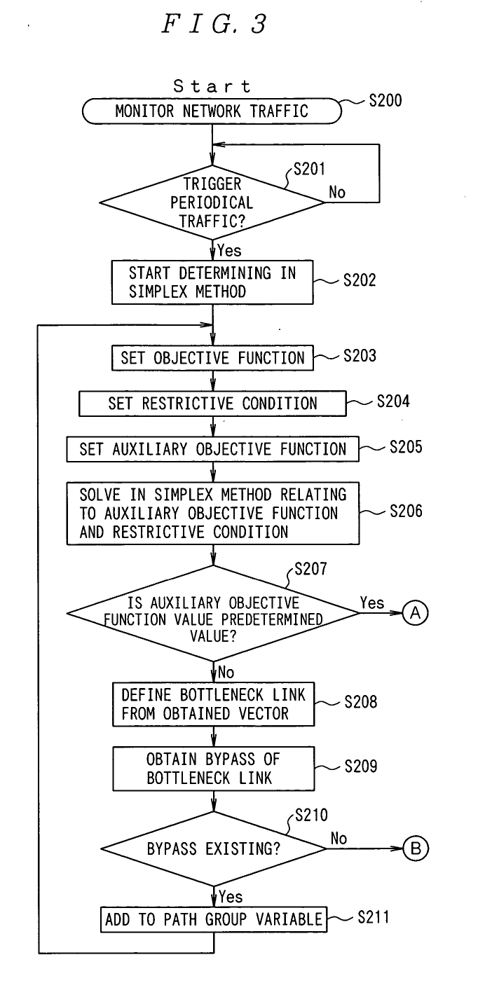

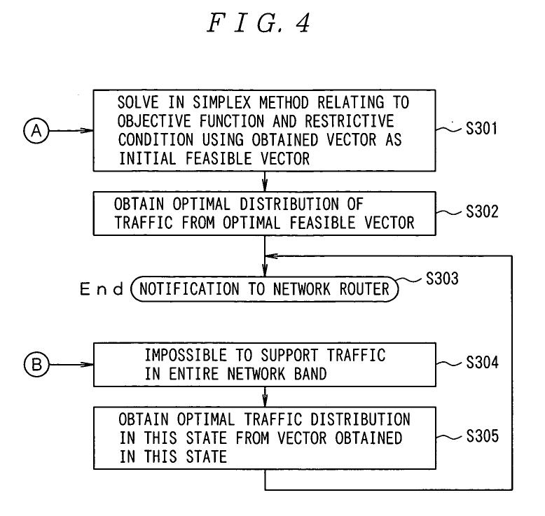

The operation of the traffic distribution control apparatus 1 with the above-mentioned configuration is described below by referring to FIGS. 3 and 4. FIGS. 3 and 4 are flowcharts showing the operation of the traffic distribution control apparatus 1.

The traffic distribution control apparatus 1 monitors the state of the traffic through the router in the network (step S200). The traffic distribution control apparatus 1 determines whether or not the current path can support the traffic. The determination can be periodically (that is, at predetermined intervals) performed, or can be started when traffic exceeding a predetermined amount flows at a burst. That is, when a predetermined period passes, or when traffic flows at a burst, it is the trigger of starting the determination (step S201). In response to the trigger, the traffic distribution control apparatus 1 starts the determination as to whether or not the current path can support the traffic (step S201→S202).

In the determination, an objective function in the simplex method is first set (step S203). For example, a function for minimizing the network resource consumption (that is, cost) is set as an objective function in the simplex method.

Then, the restrictive condition is set (step S204). For example, the restrictions on the link band, and the restrictions on the flowing traffic are set as the restrictive conditions in the simplex method. Furthermore, an auxiliary objective function for obtaining an initial feasible vector of a simplex is also set (step S205).

When the above-mentioned settings are completed, the problems of the simplex method is solved relating to the auxiliary objective function and the restrictive condition (step S206).

When the auxiliary objective function satisfies a predetermined constraint, control is passed to FIG. 4, and the obtained vector is used as an initial feasible vector in solving the simplex method on the objective function and the restrictive condition (step S207→S301). Although there are a plurality of classes (described later) on the quality from the optimal feasible vector indicating the way of traffic distribution, the optimal traffic distribution can be obtained corresponding to each of the classes (step S302). The optimal feasible vector is announced to the network router (step S303), and the process terminates.

Back in FIG. 3, in step S207, when the auxiliary objective function does not satisfies a predetermined constraint, a bottleneck link is specified from the vector in the state (step S207→S208) Then the bypass is obtained for the path which uses the bottleneck link (step S209).

When there is no bypass, it follows that the traffic cannot be supported using the band in the entire network as shown back in FIG. 4 (step S210→S304). From the vector in this state, the optimal traffic distribution in this state can be obtained (step S305). In this case, the network router is notified that there is no solution (step S303), thereby terminating the process.

Back in FIG. 3, when there is a bypass in step S210, it is added as a path group variable (step S210→S211). Then the objective function, the restrictive condition, and the auxiliary objective function are set again (steps S203, S204, and S205), and the problem is solved in the simplex method (step S206). The above-mentioned process is recursively repeated.

(Traffic Distribution Control Method)

In the traffic distribution control apparatus performing the above-mentioned operations, the following traffic distribution control method is realized. That is, the traffic distribution control method controls traffic in a network to be distributed by determining whether or not an existing path realized by a router configuring the network can support requested traffic, and includes: a determining step of determining whether or not the existing path can support the traffic by applying a simplex method to a problem of a linear programming formed by an objective function and a restrictive condition including traffic among routers configuring a network and information about a path in the network (corresponding to steps S203 to S206); and a bypass searching step of searching for a bypass other than the existing path when the determining step determines that the existing path cannot support the traffic (corresponding to steps S207 to S209), wherein a further determination is made in the determining step by adding a bypass searched for in the bypass searching step (corresponding to steps S210, S211, . . . ). Thus, the traffic distribution control method is realized. Additionally, further included is a traffic determining step (corresponding to steps S301 and S302, and steps S304 and S305) of determining traffic for minimizing consumption of resources of the network based on the determination result of the determining step. With the above-mentioned method, it can be determined whether of not the traffic can be accommodated through the current path, and when it cannot be accommodated, only a necessary path can be added, thereby optimally distributing the traffic.

(Process in Each Router)

According to the information notified by the traffic determining capability 14, each of the routers R1 to R7 updates the path information. That is, the path information about the path in the network is stored in each of the routers R1 to R7 shown in FIG. 1, and each of the routers R1 to R7 adds path information based on the information transmitted by the traffic determining capability 14 when a path is added in the above-mentioned process. When the class described later exists on the traffic, each of the routers R1 to R7 associates each class with path information according to the information transmitted by the traffic determining capability 14.

(Simplex Method)

Described below are the simplex method and the principle of finding a bottleneck link from the characteristics of the simplex method.

A simplex method refers to a method for obtaining the optimal feasible vector which maximizes (or minimizes) the objective function in a feasible region. First, a practical process of obtaining a solution is described below.

In the simplex method, it is known that a solution exists at the vertex of the feasible region. In the vertexes of a feasible region, the vertex maximizing (or minimizing) the objective function is referred to as an optimal feasible vector, and the other vertexes are referred to as feasible vectors.

The simplex method starts with obtaining any feasible vector. If a feasible vector is obtained, the optimal feasible vector is reached by repeating the movement from the obtained feasible vector to other feasible vectors based on the tilt of the objective function. On the other hand, if no feasible vector exists, that is, there is no feasible region, then no solution exists.

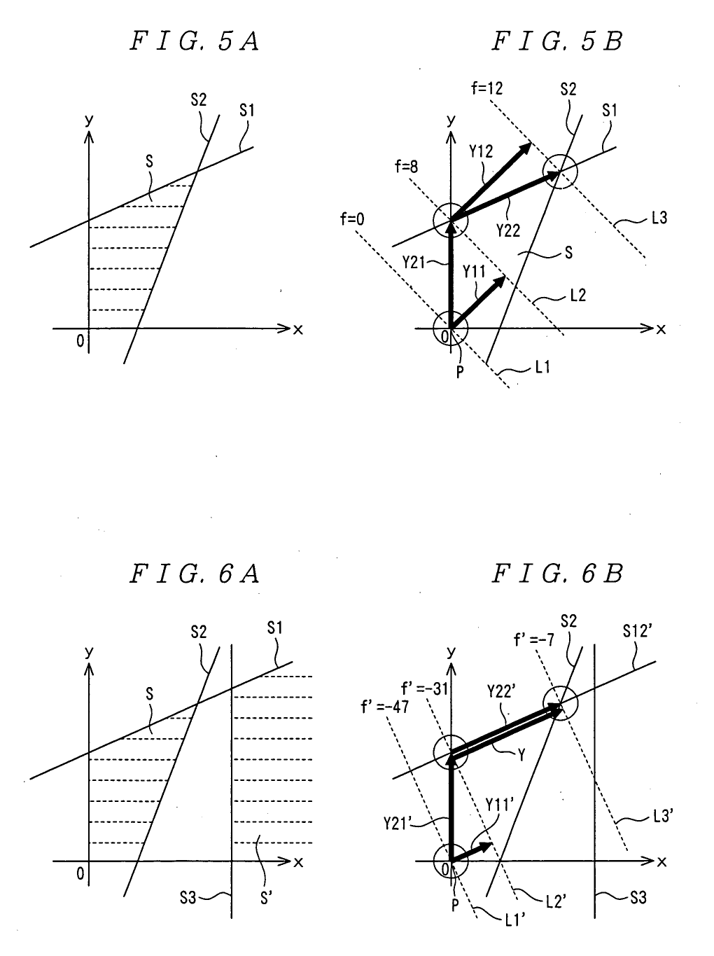

In FIG. 5A, the maximization of the objective function f=x+y is intended. The restrictive condition is
x, y≧0 (8)
−2x+4y≦32 (9)
7x−2y<8 (10)
The area completely satisfying the restrictive condition is the simplex (feasible region). It is the area S enclosed by the x axis and the y axis, and the straight line S1 and the straight line S2 shown in FIG. 5A. In FIG. 5A, the straight line S1 is a straight line by the expression (9), and the straight line S2 is a straight line by the expression (10).

The meaning of the arithmetic in the simplex method is reaching the optimal feasible vector by processing along the boundary from vertex to vertex in the increase direction of an objective function. The arithmetic is explained below by referring to FIG. 5B. As shown in FIG. 5B, the arithmetic starts with the initial feasible vector (x, y)=(0, 0). The arrows Y11 and Y12 in FIG. 5B indicate the increase direction of the objective function. FIG. 5B shows the straight line L1 (f=0) passing the origin P, the straight line L2 (f=8) passing the next vertex of the area S, and the straight line L3 (f=12) passing the intersection between the straight line S1 and the straight line S2.

In FIG. 5B, move along the boundary of the area S in the increase direction of the objective function. At the boundary, after moving in the direction of the arrow Y21, control is passed in the direction of the arrow Y22. As a result, the optimal feasible vector (x, y)=(4, 10) is obtained.

To obtain the initial feasible vector, an another objective function other than the target objective function is defined (hereinafter referred to as an auxiliary objective function), and a problem is solved in the simplex method relating to the auxiliary objective function. When the auxiliary objective function reaches a value (for example, 0), the value of each variable becomes an initial feasible vector.

In FIGS. 6A and 6B, when the objective function f=x+y is maximized, the restrictive conditions are
x, y≧0 (8)
−2x+4y≦32 (9)
7x−2y≦8 (10)
x≧7 (11)
FIG. 6A shows, in addition to the same area S as in the case shown in FIGS. 5A and 5B, the area S′. When the expressions (9) to (11) are transformed into equations using non-negative slack parameters α, β and γ, the following equations hold.
−2x+4y+α=32 (12)
7x−2y+β=8 (13)
x−y=7 (14)
Furthermore, using artificial variables z1, z2, and z3 and transposition, the expressions (12) to (14) are transformed as follows.
z1=32+2x−4y−α (15)
z2=8−7x+2y−β (16)
z3=7−x+y (17)

where
f′=−z1−z2−z3=−47+5x+2y−α−β+γ (18)
The expression (18) is an auxiliary objective function.

The auxiliary objective function is obtained by transforming the restrictive condition other than the non-negative condition such as the expression (8) into equations using a slack variable, setting an artificial variable for each restrictive condition, multiplying the artificial variable by − (minus), and a sum is obtained.

Relating to the auxiliary objective function, a solution is obtained as shown in FIG. 6B. The arrows Y11′ and Y12′, shown in FIG. 6B, indicate the increase direction of the objective function. FIG. 6B shows the straight line L1′ (f′=−47) passing the origin P, the straight line L2′ (f′=−31) passing the next vertex of the area S′, and the straight line L3′ (f′=−7) passing the intersection between the straight line S1 and the straight line S2.

The expressions (15) to (17) do not indicate the same problem as the expression (12) to (14) and expressions (9) to (11). Their problems are the same when z1, z2, and z3 are 0. Unless z1, z2, and z3 are all zero, the restrictive conditions are not satisfied. Therefore, a feasible region is provided so that all of z1, z2, and z3 are necessarily 0 when there is a feasible vector. Therefore, an auxiliary objective function is to be 0. That is, when there are values set for z1, z2, and z3 (not 0), the restrictive condition is changed.

To solve a problem in the simplex method relating to an auxiliary objective function means to perform the following process. That is, when an auxiliary objective function encounters a hyperplane, the auxiliary objective function is projected on the hyperplane, and the process is performed along the tilt on the hyperplane. If it encounters the hyperplane under a new restrictive condition, projection is performed again, and the process is performed along the tilt. The above-mentioned processes are repeated.

In FIG. 6B, when control is passed in the increase direction of the objective function along the boundary of the area S, it is passed in the direction of the arrow Y21′ at the boundary, and then in the direction of the arrow Y22′.

If control reaches a vertex, and the auxiliary objective function is not 0 although no area exists ahead, then there is no solution. In this case, there is no feasible vector.

In short, if the auxiliary objective function is a predetermined value of 0, then there is an initial feasible vector. If the auxiliary objective function is not a predetermined 0, then there is no initial feasible vector. In the example according to the present embodiment, the auxiliary objective function is not the predetermined value of 0, and there is no area in the increase direction of the objective function. Therefore, there is no solution.

That is, if a character is reached, and if the auxiliary objective function is not 0 although there is no area ahead, then it is determined that there is no solution. The vertex reached immediately before no solution is determined satisfies the restrictive condition (hyperplane) before the reached point. The value of each variable obtained at this time is defined as a provisional feasible vector.

The status indicates that the traffic in the band of the link flows as much as possible through each path, but there is still the traffic to flow. That is, since the restrictive condition for the band of a link and the restrictive condition relating to the traffic amount to flow are loose to each other, there is no feasible region. Therefore, it is possible to specify how much traffic flows from the provisional feasible vector to each path, and which link becomes a bottleneck as a result.

As shown in FIG. 6A, since the area S and the area S′ are loose to each other, there is no feasible region. The presence/absence of a feasible region is clear when a restrictive condition is shown in a two-dimensional array as shown in FIG. 6A. However, when a restrictive condition is displayed in a higher dimensional array, the determination of the presence/absence of it is difficult.

The status shown in FIG. 6B shows the process performed along some restrictive conditions until it reaches a provisional feasible vector, but there is no more area ahead. Such a status in a network means that traffic flows as much as possible in the link band through each path, but there is still traffic to flow. Therefore, if the value of a provisional feasible vector is set to a value of a path group variable, then a bottleneck link can be determined.

Therefore, when recalculation of a path is performed by a predetermined algorithm such that the bottleneck can be avoided, the optimal bypass is obtained only for the path which used the bottleneck link, and the other paths are not affected. The recalculation of the path can be performed using, for example, a Dijkstra algorithm, an expression with powers, a Warshall-Floyd algorithm. That is, a bypass is searched for by an algorithm for a shortest path based on the link cost between routers.

(Dijkstra)

Dijkstra is a method for generating a shortest path tree through which the cost can be lowest between nodes in a network. The path through which the total link cost between nodes can be lowest is recorded in the shortest path tree. If the bottleneck link cost is increased, and recalculation is performed using the Dijkstra algorithm, then a costly link is not selected as the shortest path, thereby successfully obtaining a bypass.

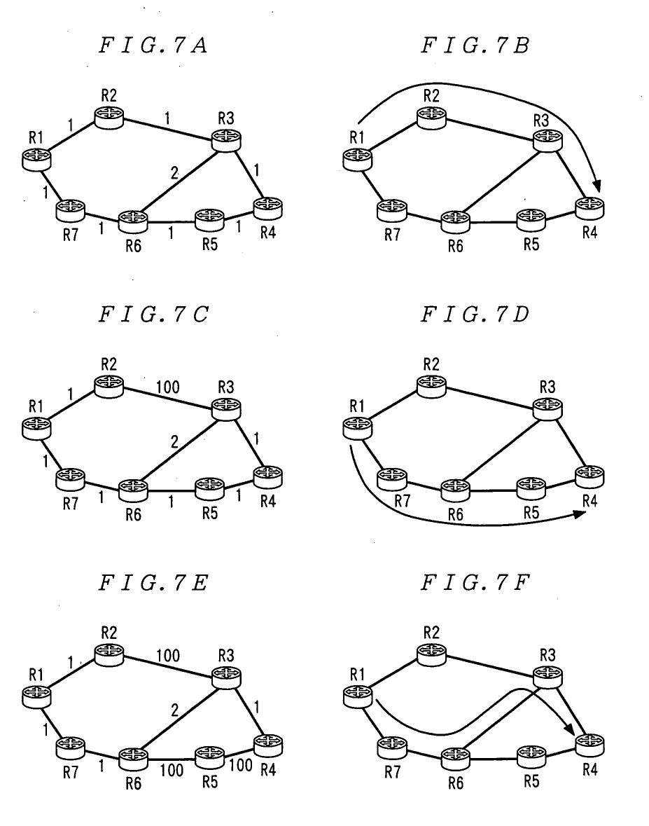

An example of the procedure of obtaining a bypass using Dijkstra is explained below by referring to FIGS. 7A to 7F. In FIG. 7A, the number between the routers indicates a link cost. That is, the link cost is 2 only between the routers R3 and R6, and 1 between other routers.

The shortest path between the routers R1 and R4 is searched for by Dijkstra. The shortest path is established through the routers 2 and 3 as shown in FIG. 7B. The link cost of the path is 3.

If no traffic flows only using the shortest path, then a bottleneck link is found and the link cost is raised. That is, as shown in FIG. 7C, the link cost between the routers R2 and R3 is raised. In this example, the link cost between the routers R2 and R3 is raised up to 100. Thus, with the link cost raised, a bypass is obtained by Dijkstra. The bypass is a path through the routers R7, R6, and R5 sequentially as shown in FIG. 7D. The link cost of the path is 4.

When no traffic flows in these two paths, a bottleneck link is found again, and its link cost is raised. That is, as shown in FIG. 7E, the link costs between the routers R6 and R5 and between the routers R5 and R4 are raised. In this example, link costs between the routers R6 and R5 and between the routers R5 and R4 are raised to 100. Thus, with the link cost raised, a further bypass is obtained by Dijkstra. The bypass is a path established through the routers R7, R6, and R3 sequentially as shown in FIG. 7F. The link cost of the path is 5.

As described above, when a bottleneck link is found, a bypass is obtained by Dijkstra. With the obtained bypass added, the simplex method is further applied.

(Warshall-Floyd)

Warshall-Floyd refers to a solution for determining the shortest path in the following procedure where “n” indicates the number of location, “L₁” indicates the name of the i-th location, and “d₁ⱼ” indicates the distance between the location i and the location j. The “distance d₁ⱼ” is not limited to a physical distance, but can be any distance in the concept of cost, time, etc. Furthermore, when the location i and the location j are not connected, the distance dᵢⱼ=∞.
procedure 1: dᵢⱼ (0)=dᵢⱼ, Pᵢⱼ=i (i, j=1, 2, 3, . . . n), and m=1

procedure 2: (a) dᵢⱼ (m)=min (dᵢⱼ (m−1), dᵢₘ (m−1)+dₘⱼ (m−1)

For (i, j) in (b) dᵢⱼ (m)<dᵢⱼ (m−1), Pᵢⱼ=Pₘⱼ.

procedure 3: The process terminates when m=n. When m<n, the value of m is incremented by 1, and control is returned to the procedure 2. At this time dᵢⱼ (m) indicates the path from Lᵢ to Lⱼ, and it is the shortest distance in the path allowing only L₁, L₂, . . . Lₘ as an intermediate passing point. When control is passed to m=n, dᵢⱼ (n) indicates the shortest path from Lᵢ to Lⱼ, and Pᵢⱼ indicates the number of the location immediately before Lⱼ in the shortest path from Lᵢ to Lⱼ.

A path obtained as a bypass by the algorithms of the above-mentioned Dijkstra and Warshall-Floyd and newly added is a necessary minimal link. Therefore, the increase of the simplex variables can be avoided. By adding the new path, the band of the entire path is expanded. Therefore, if a path is repeatedly added until the restrictive condition relating to the band and the restrictive condition on the traffic amount can afford a feasible region, then the optimal paths can be added with the smallest possible number of variables.

If the auxiliary objective function is 0, the vector obtained at the time is defined as the initial feasible vector, and the linear programming problem comprising an objective function and restrictive conditions is solved by the simplex method, thereby obtaining the optimal feasible vector.

Described below is the method of distributing traffic such that the network cost can be minimized with the above-mentioned path group variable.

As described above, the simplex method uses maximization and minimization on an objective function. That is, if the consumption of the network resources is defined as the cost of a network, and the objective function is set such that the consumption of network resources can be minimized, then it is determined whether or not there is a solution, and when there is a solution, the way of the optimal flow of traffic can be obtained as the optimal feasible vector.

If it is assumed that network resources of each link consumed per traffic is determined, the network resources consumed by each path is a total of the network resources consumed by the links contained in the path because each path is a set of links.

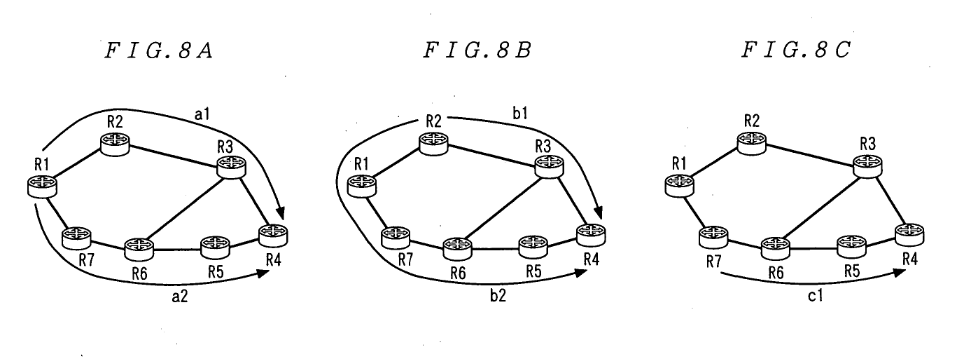

Assume that an objective function is set such that the consumption of the network resources can be minimized in the network shown in FIGS. 8A to 8C. In FIGS. 8A to 8C, the consumption of the resources in all links is assumed to be 1.

First, the consumption of the resources in the link L is C_{L}. Then, the cost C_{Pi} of the path Pi is a total of the link costs used, and the following expression holds.

$${C}_{Pi} = {\sum }_{L ∈ Pi} {C}_{L} \qquad ( 16 )$$

where xᵢ indicates the traffic flowing through the path, and the objective function f is expressed as follows.

$$f = {\sum }_{i \leq n}^{i = 1} {C}_{Pi} {X}_{1} \qquad ( 17 )$$

That is, the xᵢ minimizing the objective function f indicates the way of the flow of the traffic minimizing the consumption of the network resources.

By referring to FIG. 8A, there are the path a₁ and the path a₂ between the router R1 and the router R4. By referring to FIG. 8B, there are the path b₁ and the path b₂ between the router R2 and the router R4. When FIG. 8C is referred to, there is the path c₁ between the router R7 and the router R4.

In FIG. 8A, the cost of the path a₁ is a total of the costs of the link between the router R1 and the router R2 (hereinafter referred to as “Link (R1-R2)” or the like) and the Link (R2-R3). Therefore, 1+1+1=3 indicates the cost. Furthermore, the cost of the path a₂ is a total of the costs of the Link (R1-R7), Link (R7-R6), Link (R6-R5), and Link (R5-R4). Therefore, 1+1+1+1=4 is the cost. Similarly, the costs of the path b₁ and path b₂ shown in FIG. 8B, and the path c₁ shown in FIG. 8C can be obtained. That is, the cost of the path b₁ is 2, the cost of the path b₂ is 5, and the cost of the path c₁ is 3.

Thus, the objective function obtained as a product of the consumption of the resources and the flow rate of the path of each path is calculated by the following expression.
f=3a₁+4a₂+2b₁+5b₂+3c₁
The objective function is the value of the traffic amount of each path as a variable, and when the consumption of the network resources of a path is set as a constant (1 in this example), the consumption of the network resources can be minimized.

### Embodiments

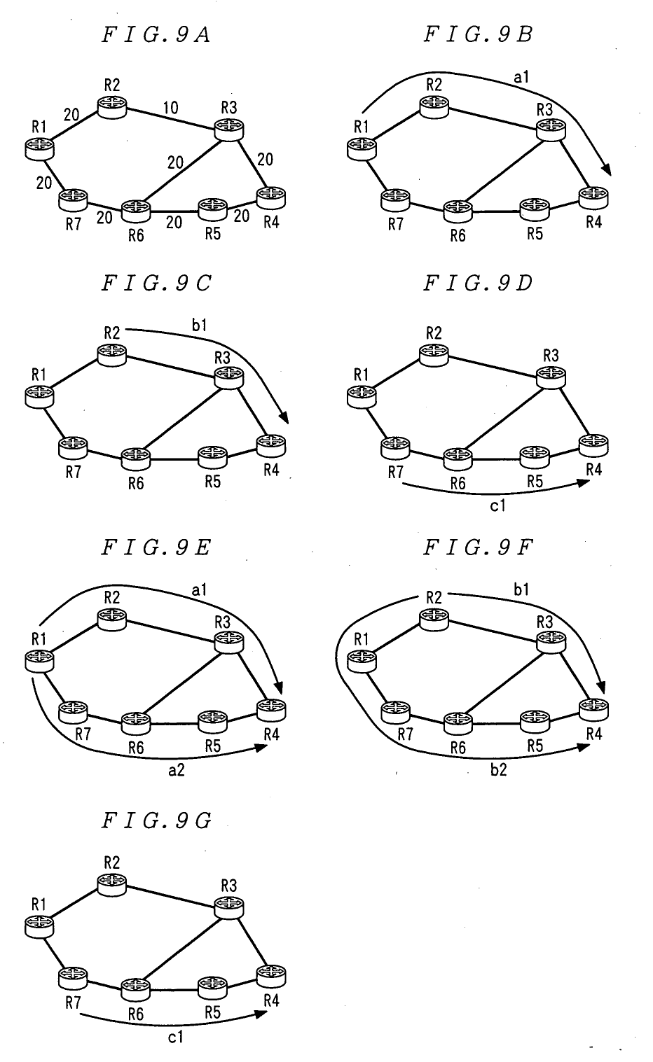

The first to third embodiments of the present invention are described below by referring to FIGS. 9A to 9G, 10A to 10G, 11A to 11G, and 12A to 12C.

### First Embodiment

The topology of the network according to the present embodiment is shown in FIG. 9A. In FIG. 9A, the band of the link is 10 Mbps only between the router R2 and the router R3, and 20 Mbps between other routers. Assume that the network resources consumed by each link for unit traffic is 1.

The traffic between the router R1 and the router R4, between the router R2 and the router R4, and between the router R7 and the router R4 is 5 Mbps, respectively. As shown in FIGS. 9B, 9C, and 9D, the currently used paths are a₁, b₁, and c₁. The objective function is set such that the consumption of the network resources can be minimized, and the restrictive condition on the link, the restrictive condition on the traffic amount, and the auxiliary objective function are set, and it is determined whether or not the current link can support the traffic.

As shown in FIGS. 9B, 9C, and 9D, when the problem is solved by the simplex method relating to the objective function f=3a₁+2b₁+3c₁, the feasible vector is obtained as follows.
(a₁, b₁, c₁)=(5, 5, 5)
In this state, since the traffic can be supported by the current path only, the traffic can be transferred.

Then, assume that the traffic has increased up to 10 Mbps respectively between the router R1 and the router R4, between the router R2 and the router R4, and between the router R7 and the router R4. The currently used paths are still the paths a₁, b₁, and c₁.

The objective function f=3a₁+2b₁+3c₁ is set such that the consumption of the network resources can be minimized, and the restrictive condition on the link, the restrictive condition on the traffic amount, and the auxiliary objective function are set. Then, it is determined in the simplex method whether or not the current link can support the traffic.

In this state, the provisional feasible vector is represented as follows,
(a₁, b₁, c₁)=(10, 0, 10)
and stops without the auxiliary objective function set to 0. That is, it is indicated that the limit of 10 Mbps flows at the Link (R2-R3), and the provisional feasible vector indicates that the Link (R2-R3) is a bottleneck link.

The next pass is calculated by Dijkstra to avoid the Link (R2-R3) which is the above-mentioned bottleneck link. Thus, as shown in FIGS. 9E, 9F, and 9G, new bypaths a₂ and b₂ are added. With the paths added, the determination is performed again in the simplex method.

That is, the objective function
f=3a₁+4a₂+2b₁+5b₂+3c₁
is solved in the simplex method. Thus, it is determined that the traffic can be supported, and the feasible vector is obtained.
(a₁, a₂, b₁, b₂, c₁)=(0, 10, 10, 0, 10)

### Second Embodiment

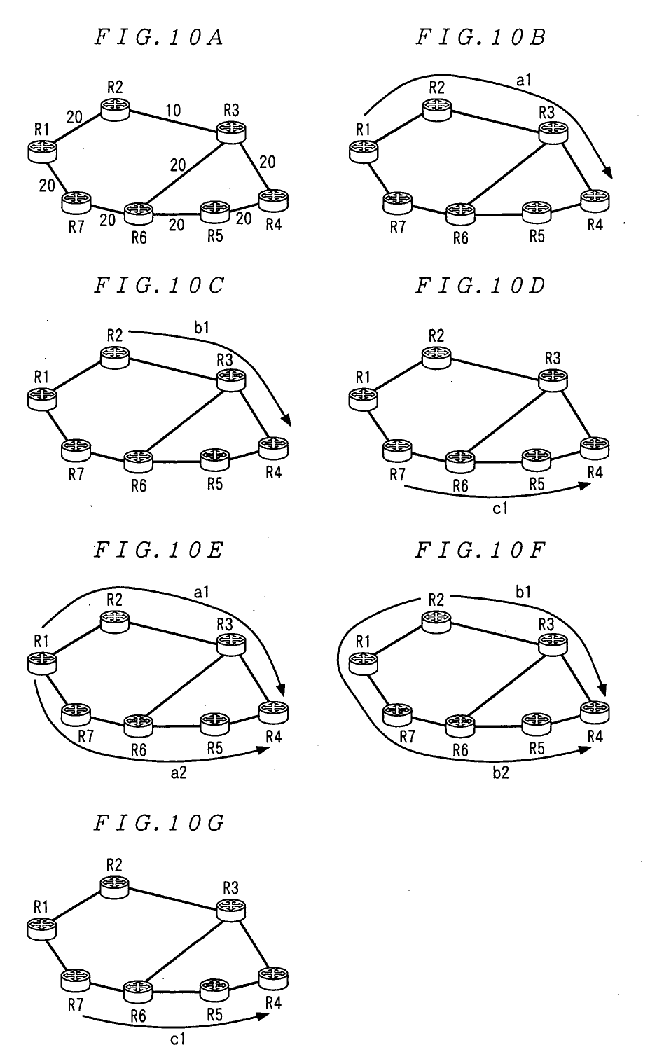

The topology of the network according to the present embodiment is shown in FIG. 10A. In FIG. 10A, the band of the link is 10 Mbps only between the router R2 and the router R3, and 20 Mbps between other routers. Assume that the network resources consumed by each link for unit traffic is 1.

In the present embodiment, there are two classes indicating the priorities. That is, there are classes A and B. The priorities of the classes are class A >class B.

The traffic between the router R1 and the router R4, between the router R2 and the router R4, and between the router R7 and the router R4 is 5 Mbps for the classes A and B respectively. As shown in FIGS. 10B, 10C, and 10D, the currently used paths are a₁, b₁, and c₁. The objective function is set such that the consumption of the network resources can be minimized, and the restrictive condition on the link, and the restrictive condition on the traffic amount are set.

If there is a quality request to transmit the traffic of class A through the shortest path, the conditions a₁≧5, b₁≧5, and c₁≧5 are added as indicating the request above. The expression indicates that the traffic over the class A flows through the shortest path. From the restrictive condition, the auxiliary objective function is set, and it is determined whether or not the current link can support the traffic.

As shown in FIGS. 10B, 10C, and 10D, if the problem is solved in the simplex method relating to the objective function
f=3a₁+2b₁+3c₁,
then the provisional feasible vector is represented as follows, and there is no solution.
(a₁, b₁, c₁)=(5, 5, 10)

In the state, the provisional feasible vector is
(a₁, b₁, c₁)=(5, 5, 10)
and stops without the auxiliary objective function set to 0. From the provisional feasible vector, it is indicated that the Link (R2-R3) is a bottleneck link.

To avoid the bottleneck link, the next path is calculated by Dijkstra to obtain a bypass. As a result, new paths a₂ and b₂ are obtained as shown in FIGS. 10E, 10F, and 10G. They are added as variables of the objective function.

Relating to the variable added objective function
f=3a₁+4a₂+2b₁+5b₂+3c₁,
the expressions a₁≧5, b₁≧5, c₁≧5 with the quality request taken into account are added, and it is determined again in the simplex method. It is determined that the traffic can be supported, and the feasible vector
(a₁, a₂, b₁, b₂, c₁)=(5, 5, 5, 5, 10)
is obtained as the optimal solution satisfying the quality request.

### Third Embodiment

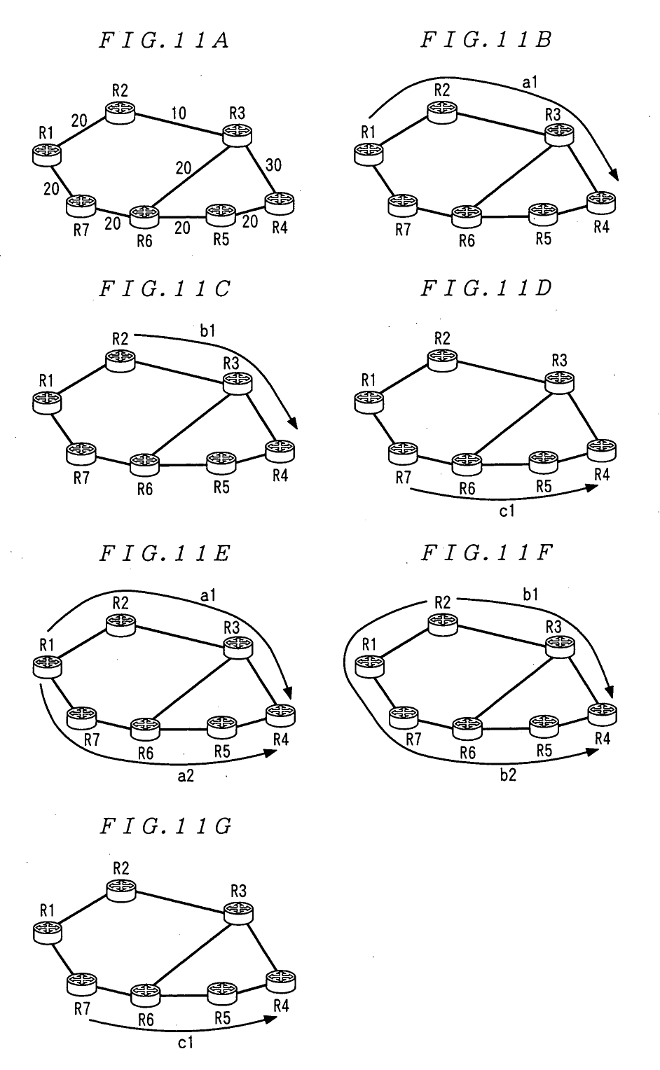

The topology of the network according to the present embodiment is shown in FIG. 11A. In FIG. 11A, the band of the link is 10 Mbps only between the router R2 and the router R3, and 20 Mbps between other routers. Assume that the network resources consumed by each link for unit traffic is 1.

In the present embodiment, there are three classes. That is, there are classes A, B, and C. The priorities of the classes are class A>class B>class C.

The traffic between the router R1 and the router R4, between the router R2 and the router R4, and between the router R7 and the router R4 is 5 Mbps for the classes A, B, and C respectively. As shown in FIGS. 11B, 11C, and 11D, the currently used paths are a₁, b₁, and c₁. The objective function is set such that the consumption of the network resources can be minimized, and the restrictive condition on the link, and the restrictive condition on the traffic amount are set.

If there is a quality request to transmit the traffic of class A through the shortest path, the conditions a₁≧5, b₁>5, and c₁>5 are added as indicating the request above. The expression indicates that the traffic over the class A flows through the shortest path. From the restrictive condition, the auxiliary objective function is set, and it is determined whether or not the current link can support the traffic.

As shown in FIGS. 11B, 11C, and 11D, if the problem is solved in the simplex method relating to the objective function
f=3a₁+2b₁+3c₁,
then the provisional feasible vector is represented as follows, and there is no solution.
(a₁, b₁, c₁)=(5, 5, 10)

In the state, the provisional feasible vector is
(a₁, b₁, c₁)=(5, 5, 10)
and stops without the auxiliary objective function set to 0. From the provisional feasible vector, it is indicated that the Link (R2-R3) is a bottleneck link.

To avoid the bottleneck link, the next path is calculated by Dijkstra to obtain a bypass. As a result, new paths a₂ and b₂ are obtained as shown in FIGS. 11E, 11F, and 11G. They are added as variables of the objective function.

Relating to the variable added objective function
f=3a₁+4a₂+2b₁+5b₂+3c₁,
the expressions a₁≧5, b₁≧5, c₁≧5 with the quality request taken into account are added, and it is determined again in the simplex method. It is determined that the feasible vector
(a₁, a₂, b₁, b₂, c₁)=(5, 5, 5, 5, 10)
has no solution.

In the state, the provisional feasible vector is
(a₁, a₂, b₁, b₂, c₁)=(5, 5, 5, 5, 10)
and stops without the auxiliary objective function set to 0. From the provisional feasible vector, it is indicated that the Link (R6-R5) and Link (R5-R4) are bottleneck links.

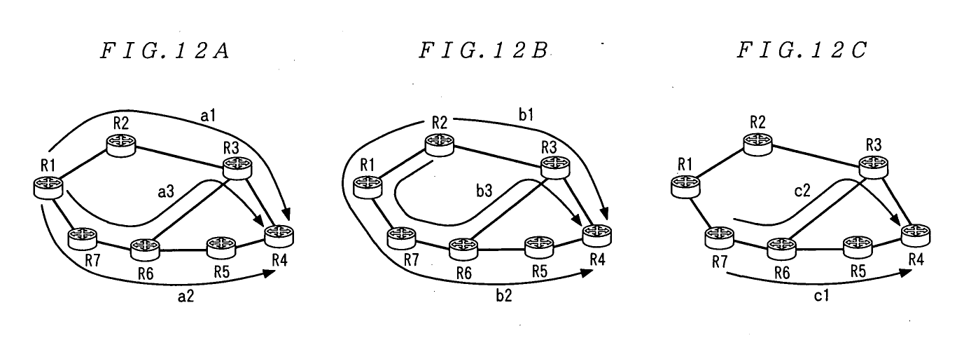

To avoid the bottleneck links, the next path is calculated by Dijkstra to obtain a bypass. As a result, new paths a₃, b₃, and c₂ are obtained as shown in FIGS. 12A, 12B, and 12C. They are added as variables of the objective function.

Relating to the variable added objective function
f=3a₁+4a₂+4a₃+2b₁+5b₂+5b₃+3c₁+3c₂,
the expressions a₁≧5, b₁≧5, c₁≧5 with the quality request taken into account are added, and it is determined again in the simplex method. It is determined that the traffic can be supported with a bypass added, and the feasible vector
(a₁, a₂, a₃, b₁, b₂, b₃, c₁, c₂)=(5, 5, 5, 5, 5, 5, 10, 5)
is obtained as the optimal solution satisfying the quality request.

There are three types of paths, that is, shortest path, the second path, and the third path, and higher priority traffic is assigned to a better path. That is, relating to the paths between the router R1 and the router R4, and between the router R2 and the router R4, the class A is assigned to the shortest path, the class B is assigned to the second shortest path, and the class C is assigned to the third shortest path, respectively.

Relating to the path between the router R7 and the router R4, the class A and the class B are assigned to the shortest path, and the class C is assigned to the second shortest path respectively.

Then, assume that the traffic has increased up to 10 Mbps respectively between the router R1 and the router R4, between the router R2 and the router R4, and between the router R7 and the router R4.

Relating to the Objective Function
f=3a₁+4a₂+4a₃+2b₁+5b₂+5b₃+3c₁+3c₂,
it is determined again in the simplex method with the quality request taken into account. In this state, the feasible vector
(a₁, a₂, a₃, b₁, b₂, b₃, c₁, c₂)=(5, 5, 5, 5, 5, 5, 10, 5)
has no solution, and stops without the auxiliary objective function set to 0. From the provisional feasible vector, it is indicated that the Link (R3-R4) is a bottleneck link.

To avoid the bottleneck link, the next path is calculated by Dijkstra to obtain a bypass. However, no more new paths are found. That is, no more paths can be added to the network, and no true solution exists.

Since no path can be added, the traffic is made to flow with the feasible vector
(a₁, a₂, a₃, b₁, b₂, b₃, c₁, c₂)=(5, 5, 5, 5, 5, 5, 10, 5).
For example, if well-known DiffServ (Differentiated Services), etc. are combined, only the traffic having a lower priority can be discarded. In the present embodiment, only the class C having a lower priority can be discarded.

(Variation)

In the above-mentioned third embodiment, the algorithm of the correspondence of each class to a path flow rate by assigning a better path to a class having a higher priority is described, but the algorithm can be different by setting such that, for example, the traffic can flow without interference with each other having traffic of a higher priority, the traffic can flow through a pass satisfying the band request if the router requires a band, etc.

Furthermore, a large network is normally divided into areas, and a limited number of routers span each area. Therefore, if the present invention is applied to each area, the scalability can be satisfied.

When a bottleneck link is found, not only a link having the use rate of 100%, but also a link having the use rate of 70% or more, for example, can be defined as a bottleneck link, thereby successfully reducing the times of recursion with the number of variables added at a time, though.

In the explanation above, the consumption of the network resources of each link is used as a constant, but a value other than a constant canal so be set. For example, a delay in queuing increases exponentially with an increase in use rate of a queue. Therefore, the consumption of network resources can be changed with the use rate of a link.

Furthermore, an objective function can be set not only to minimize the consumption of network resources, but also to minimize other network costs, for example, a delay, or can be set based on the number of hops.

When the delay is minimized, the coefficient of each path variable indicates a total delay of each link.

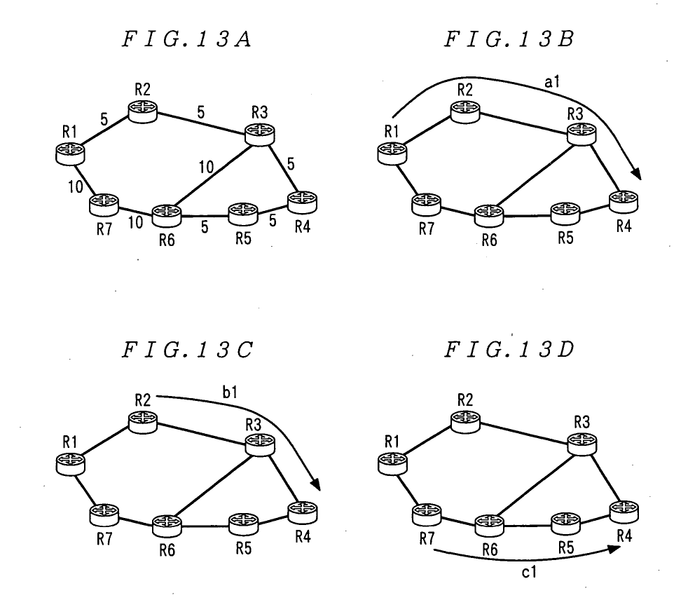

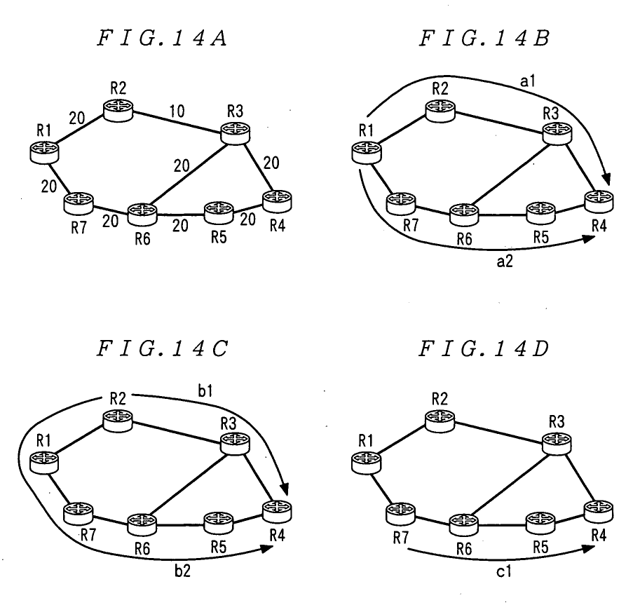

In the network shown in FIG. 13A, assume that the delay of each link of the router R1 to the router R7, the router R7 to the router R6, and the router R6 to the router R3 is 10 Mbps, and the delay of the link between other routers is 5 Mbps.

Relating to the paths a₁, b₁, and c₁ shown in FIGS. 13B, 13C, and 13D, the objective function based on the delay is represented as follows.

coefficient of a₁=5+5+5=15

coefficient of b₁=5 +5=10

coefficient of c₁=10 +5 +5=20

Therefore, the objective function is
r=15a₁+10b₁+20c₁

To the objective function, as in the above-mentioned embodiment, a simplex is applied. In this case, the bottleneck link can be avoided by Dijkstra, etc.

On the other hand, relating to the path a₁, b₁, and c₁ shown in FIGS. 13B, 13C, and 13D, the objective function based on the number of hops is represented as follows. That is, since the number of hops between the adjacent routers is 1,

coefficient of a₁=1+1+1=3

coefficient of b₁=1+1=2

coefficient of c₁=1+1+1=3

Therefore, the objective function is
f=3a₁+2b₁+3c₁
To the objective function, as in the above-mentioned embodiment, a simplex is applied. In this case, the bottleneck link can be avoided by the above-mentioned Dijkstra, etc.

Industrial Applicability

As explained above, the present invention can determine whether or not the current path can accommodate the traffic by finding a bottleneck link, adding a bypass, and further applying a simplex method when there is no optimal solution in a simplex method. If the traffic cannot be accommodated, only a necessary path can be added, and the optimal traffic distribution can be performed by setting the objective function based on the network cost such as the consumption of network resources, a delay, the number of hops, etc.

1. A traffic distribution control apparatus which controls traffic in a network to be distributed by determining whether or not an existing path realized by a router configuring the network can support requested traffic, comprising:
determination means for determining whether or not the existing path can support the traffic by applying a simplex method to a problem of a linear programming formed by an objective function and a restrictive condition including traffic among routers configuring a network and information about a path in the network; and
bypass search means for searching for a bypass other than the existing path when said determination means determines that the existing path cannot support the traffic, wherein
said determination means further makes a determination by adding a bypass searched for by said bypass search means.

2. The traffic distribution control apparatus according to claim 1, wherein
said determination means finds a bottleneck link causing a factor disabling the support of the requested traffic by applying the simplex method to an auxiliary objective function determined by the restrictive condition; and
said bypass search means searches for the bypass for bypassing the bottleneck link.

3. The traffic distribution control apparatus according to claim 1, wherein
said bypass search means searches for the bypass using an algorithm of searching for a shortest path based on a link cost among the routers.

4. The traffic distribution control apparatus according to claim 1, further comprising
traffic determination means for determining traffic for minimizing the cost of the network based on a determination result of said determination means.

5. A traffic distribution control method for controlling traffic in a network to be distributed by determining whether or not an existing path realized by a router configuring the network can support requested traffic, comprising:
a determining step of determining whether or not the existing path can support the traffic by applying a simplex method to a problem of a linear programming formed by an objective function and a restrictive condition including traffic among routers configuring a network and information about a path in the network; and
a bypass searching step of searching for a bypass other than the existing path when said determining step determines that the existing path cannot support the traffic, wherein
a further determination is made in said determining step by adding a bypass searched for in said bypass searching step.

6. The traffic distribution control method according to claim 5, further comprising
a traffic determining step of determining traffic for minimizing consumption of resources of the network based on a determination result of said determining step.

7. The traffic distribution control apparatus according to claim 2, wherein
said bypass search means searches for the bypass using an algorithm of searching for a shortest path based on a link cost among the routers.

8. The traffic distribution control apparatus according to claim 2, further comprising
traffic determination means for determining traffic for minimizing the cost of the network based on a determination result of said determination means.
